(19) United States
(12) Patent Application Publication
(10) Pub. No.: US 2010/0303239 A1
(43) Pub. Date: Dec. 2, 2010

(54) METHOD AND APPARATUS FOR PROTECTING ROOT KEY IN CONTROL SYSTEM

(75) Inventors: Michael James, Longmont, CO (US); Darren Lasko, Longmont, CO (US); John W. Williams, Longmont, CO (US)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/472,696

(22) Filed: May 27, 2009

(51) Int. Cl. H04L 9/06; G06F 12/02; H04L 9/28

(52) U.S. Cl. 380/277; 711/103; 711/E12.008; 713/189

(57) ABSTRACT

A system-on-chip control system includes a processor for generating a root key for protecting data stored in a memory device connected to the control system, a root key storage unit for storing the root key, and a debug port configured to enable an external device to access the control system. The processor keeps the debug port locked to prevent the external device from accessing the control system if a root key is stored in the storage unit, and unlocks the debug port to enable the external device to access the control system after the root key is erased.

### FIELD OF INVENTION

The present invention generally relates to the protection of a root key stored in a control system of a storage device for providing security to data stored in the storage device.

### BACKGROUND OF THE INVENTION

A system-on-chip (SOC) is a device that holds all of the necessary hardware and electronic circuitry for a complete system. Typically, an SOC includes memory, a microprocessor, peripheral interfaces, I/O logic control and other components. An SOC that controls a storage device such as a hard disk drive (HDD) or a solid state drive (SSD) also has some debug ports that are used for manufacturing testing and failure analysis. One such port is used as a JTAG interface which enables a programmer to access an on-chip debug module which is integrated into a microprocessor. The debug module enables the programmer to debug the software of the SOC. While useful for its intended purposes, the debug port can potentially compromise the security implementation in the storage device. For example, using the debug port, it may be possible for an unauthorized person to access the root key stored in the SOC. As known, a root key is a unique random key which is used to cryptographically protect secret or confidential information stored in the storage device, such as, for example, encryption keys, passwords, bank account numbers, credit card numbers, etc.

### SUMMARY OF THE INVENTION

The present invention is directed to a system-on-chip (SOC) control system. One embodiment of the invention includes a processor for generating a root key for protecting data stored in a memory device connected to the control system, a root key storage unit for storing the root key, and a debug port configured to enable an external device to access the control system. The processor keeps the debug port locked to prevent the external device from accessing the control system if a root key is stored in the storage unit, and unlocks the debug port to enable the external device to access the control system after the root key is erased upon receiving a command to erase the root key from the host.

### BRIEF DESCRIPTION OF THE DRAWINGS

FIG. 1 is a block diagram of a disk drive in accordance with one embodiment of the present invention;

FIG. 2 is a block diagram of a system-on-chip (SOC) shown in FIG. 1;

FIG. 3 is a flowchart describing a process for storing a root key in the SOC shown in FIG. 2; and

FIG. 4 is a flowchart describing a process for accessing the SOC shown in FIG. 2 through a debug port.

### DETAILED DESCRIPTION OF THE PREFERRED EMBODIMENTS

As a way of protecting secret or confidential information in a storage device such as a hard disk drive (HDD) or a solid state drive (SSD), a unique root key is generated and stored in a non-volatile memory that exists within the control system of the storage device. The root key is only accessible internal to the system-on-chip (SOC), even in the case of a system failure requiring failure analysis of the SOC or the system. In one embodiment of the present invention, the debug port of the SOC is locked before the root key is generated or stored. In the event of a system failure requiring failure analysis, all remnants of the root key in the control system are erased before the debug port is unlocked.

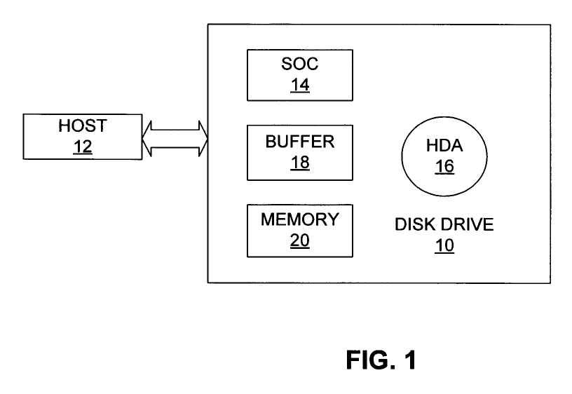

Turning now to FIG. 1, a storage device in accordance with one embodiment of the present invention is implemented in a hard disk drive (HDD) 10, which may be a magnetic, optical or magneto-optical drive, and is adapted to be communicatively connected to a host device 12 such as a computer. The disk drive 10 includes a system-on-chip (SOC) 14, a head disk assembly (HDA) 16, a buffer 18 and a memory 20. It should be understood that while an embodiment is described with respect to an HDD, the present invention can also be implemented in a solid state drive (SSD) that employs a solid state storage medium such as FLASH, rather than a disk medium as in the HDD.

The buffer 18 is preferably a DRAM or other memory devices such as FLASH or SRAM, and stores data used by the SOC 14 such as user data, disk drive variables tables, code for servo processor execution and defect management information. The memory 20 is a nonvolatile storage device such as FLASH memory or a ROM. The memory 20 stores programs and tables used in initializing and in some cases accomplishing the above-mentioned SOC 14 responsibilities, including codes to be executed by the SOC 14. The HDA 16, although not shown, includes one or more disks, a spindle motor for rotating the disk(s), a read/write head(s) for reading data from and writing data on the disk(s), and a head actuator for positioning the head(s) on the disk(s).

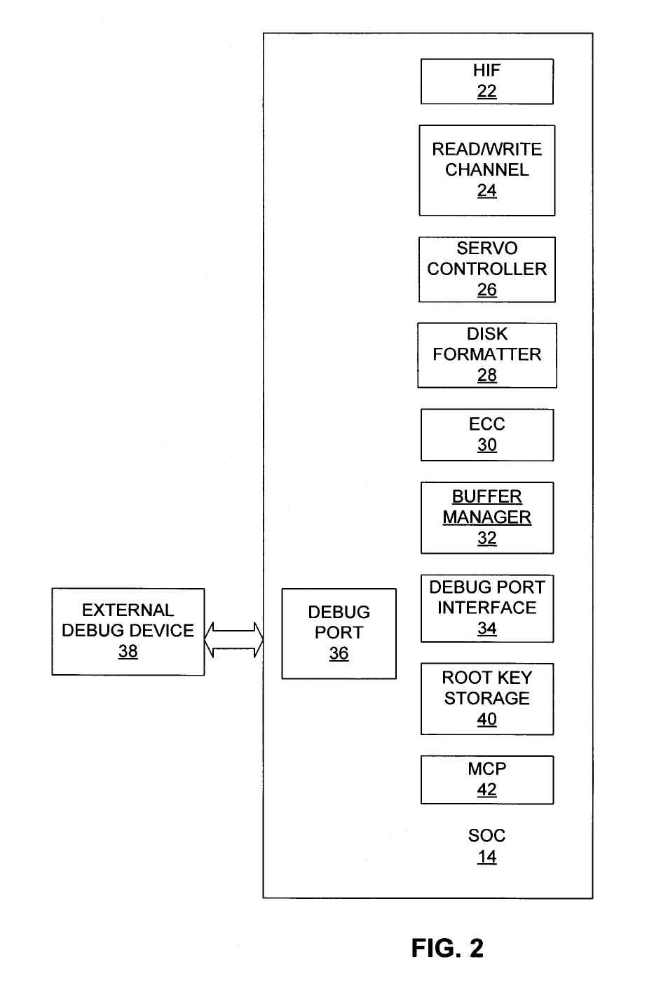

Referring to FIG. 2, the SOC 14 includes a host interface (HIF) 22 for processing commands from the host 12 and transmitting and accepting data to and from the host, a read/write channel 24 for translating digital data from the SOC 14 to a format capable of being either written to, or read from the disk(s) in the HDA 16, and a servo controller 26 for controlling the HDA 16 including the rotational speed of the spindle motor used to rotate the disks and positioning of the read/write head. A disk formatter 28 transfers data from the buffer 18 to the read/write channel 24, and reads data from the disks and transfers to the buffer. The timing of when to write or read data to or from the disk is controlled by the disk formatter 28. An error correcting code (ECC) circuit 30 in the SOC 14 adds check symbols to the data as data passes into the disk formatter (during disk writes) and corrects any errors as data passes out of the disk formatter 28 (during disk reads).

The SOC 14 further includes a buffer manager 32 used to interface between the HIF 22 and the buffer 18, or between the disk formatter 28 and the buffer. The HIF 22 and the disk formatter 28 make requests of the buffer manager 32 to either accept data and write it to the buffer 18, or to retrieve data from the buffer. Other components of the SOC 14 may also interface with the buffer manager 32 to store and retrieve data from the buffer 18, including the ECC circuit 30. The buffer manager 32 responsibilities include management of caching algorithms, which involves searching for a cache hit or miss for each command, and allocation of segments of the buffer 18 for different commands or sets of commands.

Also included in the SOC 14 is a debug port interface 34 which is adapted and configured to enable a manufacturer or other users to access the SOC 14 for manufacturing testing and failure analysis. More specifically, the debug port interface 34 enables the user to analyze the state internal to the SOC 14, and write and read registers and other memory elements within the SOC. Access to the SOC 14 may be made through a debug port 36 using an external debug device 38 such as a computer or a test equipment, which communicates with the debug port interface 34 to conduct the desired testing and/or failure analysis.

A root key storage 40 is provided in the SOC 14 for storing a root key for cryptographically protecting secret or confidential information stored in the disk drive 10, such as, for example, encryption keys, passwords, bank account numbers, credit card numbers, etc. The root key storage 40 may be implemented in either embedded FLASH or a one-time-programmable (OTP) memory element, so that it is not accessible through the debug port 36 or external to the SOC. If the root key storage 40 is an embedded FLASH, it should not be connected to pins for reading/writing purposes. It should not be possible to access the FLASH when the debug port 36 has been blocked or locked. An OTP is generally a fuse structure within the SOC 14 where each bit is represented by a fuse. Each fuse can be optionally left intact or blown to represent a value. Most OTP implementations return a logical 1 for each bit position with a fuse that has not been blown and return a logical 0 for each bit position with a fuse that has been blown. By using a structure of fuses, the OTP can act as a persistent memory that can keep its state across power cycles.

A main control processor (MCP) 42 is provided in the SOC 14 for overall control of the disk drive 10 including enabling the other components of the SOC 14 to perform their functions, which might include processing of commands from the host, management of caching algorithms, and management of mechanical positioning of heads and rotational media (motor controls) in the HDA 16. In one embodiment of the invention, the main control processor 42 generates the root key, stores it in the root key storage 40 and, when called for, erases it from the root key storage 40. The main control processor 42 also controls access to the SOC 14 by the external device 38 by controlling the locking and unlocking (or blocking and unblocking) of the debug port 36.

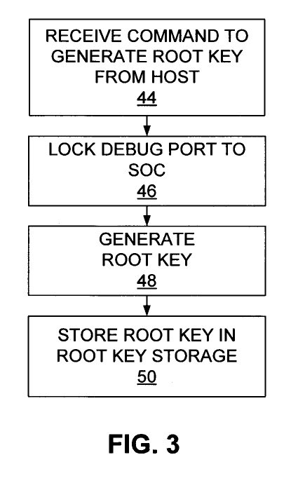

Referring now to FIG. 3, a process for generating and storing a root key in accordance with one embodiment of the invention is described. When the MCP 42 receives a command to generate a root key from the host 12 (Block 44), the MCP 42 locks or blocks the debug port 36 (Block 46) so that the SOC 14 is inaccessible to the external debug device 38. The MCP 42 then generates a root key (Block 48), and stores it in the root key storage 40 (Block 50).

In one embodiment, the MCP 42 generates the root key by collecting entropy, and executing a pseudo-random number generator algorithm, utilizing the entropy collected. The algorithm outputs a key that can be used as the root key. As known in the field of computing, entropy is the randomness collected by an operating system or application for use in cryptography or other uses that require random data. This randomness is often collected from hardware sources such as mouse movements or variations in the spin rate of disk media.

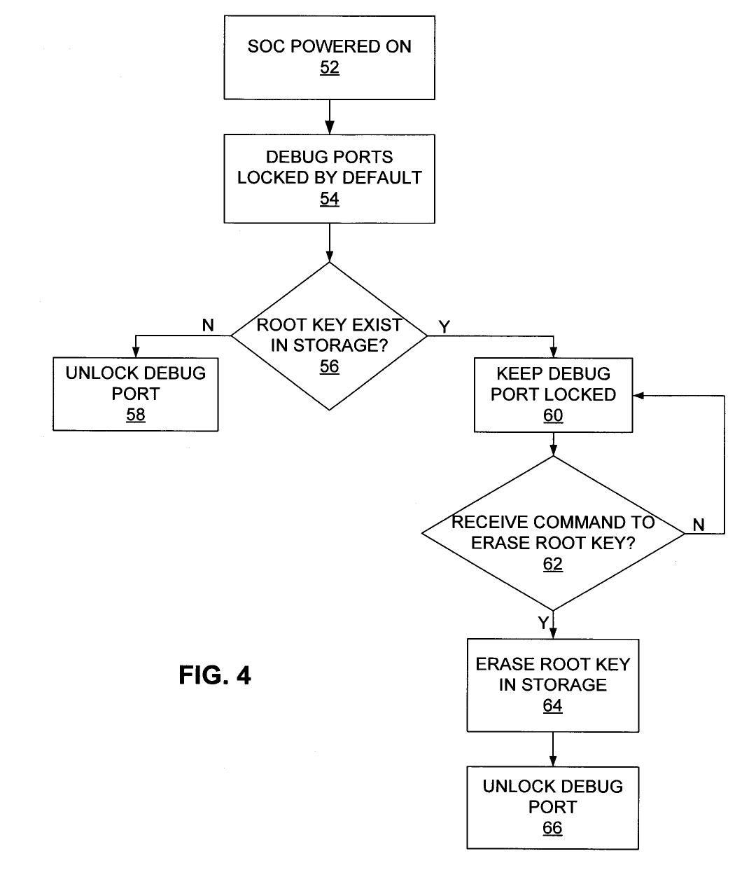

FIG. 4 describes a process for accessing the SOC 14 through the debug port 36 in accordance with an embodiment of the invention. Whenever the SOC 14 is powered on (Block 52), the debug port 36 is locked by default 42 (Block 54). Then, if the MCP 42 (or a hardware state machine (not shown)) determines that a root key does not exist in the root key storage 40, the debug port 36 is unlocked by the MCP (Block 58).

On the other hand, if it is determined that the root key does exist in the root key storage 40, the debug port 36 is kept locked or blocked (Block 60). While the debug port 36 is locked, the host 12 may issue a command to erase the root key (Block 62) to enable the external debug device 38 to access the SOC 14 for testing and/or failure analysis, for example. If no such command is received, the debug port 36 is kept locked. However, if an erase command is received, the MCP 42 erases the root key stored in the root key storage 40 (Block 64). Once the root key is erased, the debug port 36 is unlocked by the MCP 42 (Block 66) and the SOC 14 is accessible to the external debug device 38.

In the above-described process, the user is allowed to access the SOC through the debug port 36 to perform various functions, including testing and failure analysis. However, the user does not have access to the root key since it is erased, thus preserving the secrets stored in the disk drive that were cryptographically protected by the root key.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A system-on-chip control system, comprising:
a processor for generating a root key for protecting data stored in a memory device connected to the control system;
a root key storage unit for storing the root key; and
a debug port configured to enable an external device to access the control system;
wherein the processor keeps the debug port locked to prevent the external device from accessing the control system if a root key is stored in the storage unit, and unlocks the debug port to enable the external device to access the control system after the root key is erased.

2. The control system as defined in claim 1, wherein the debug port is locked by default when the control system is powered on.

3. The control system as defined in claim 1, wherein the processor erases the root key upon receiving a command to erase the root key from a host device connected to the control system.

4. The control system as defined in claim 1, wherein the root key is generated by entropy collected by the processor.

5. The control system as defined in claim 1, wherein said root key storage unit comprises FLASH memory or a one-time-programmable (OTP) memory.

6. The control system as defined in claim 1, further comprising a debug port interface for enabling the external device to access the control system via the debug port.

7. A method for protecting data stored in a memory device connected to an on-chip control system having a debug port configured to enable an external device to access the control system, the method comprising:
generating a root key for accessing data stored in the memory device;
storing the root key in a root key storage unit; and
keeping the debug port locked to prevent the external device from accessing the data in the memory device through the control system if the root key is stored in the storage unit, and unlocking the debug port to enable the external device to access the control system after the root key is erased.

8. The method as defined in claim 7, wherein the debug port is locked by default when the control system is powered on.

9. The method as defined in claim 7, wherein the root key is erased upon receiving a command to erase the root key from a host device connected to the control system.

10. The method as defined in claim 7, wherein the root key is generated by entropy collected by a processor in the control system.

11. The method as defined in claim 1, wherein the root key storage unit comprises FLASH memory or a one-time-programmable (OTP) memory.

12. A system-on-chip control system of a storage device, comprising:
a host interface configured to be in communication with a host device;
a processor for generating a root key for protecting data stored in a memory device connected to the control system;
a root key storage unit for storing the root key;
a debug port configured to enable an external device to access the control system; and
wherein the processor keeps the debug port locked to prevent the external device from accessing the control system if a root key is stored in the storage unit, and unlocks the debug port to enable the external device to access the control system after the root key is erased.

13. The control system as defined in claim 12, wherein said storage device comprises a disk drive.

14. The storage apparatus as defined in claim 12, wherein said storage device comprises a solid state drive.

15. A storage apparatus, comprising:
at least one storage medium;
a system-on-chip controller including:
a host interface configured to be in communication with a host device;
a processor for generating a root key for protecting data stored in a memory device connected to the control system;
a root key storage unit for storing the root key;
a debug port configured to enable an external device to access the control system; and
wherein the processor keeps the debug port locked to prevent the external device from accessing the control system if a root key is stored in the storage unit, and unlocks the debug port to enable the external device to access the control system after the root key is erased;
a buffer for storing data used by the system-on-chip controller; and
a non-volatile memory for storing programs and tables used by the system-on-chip controller.

16. The storage apparatus as defined in claim 15, wherein said storage medium comprises a disk medium.

17. The storage apparatus as defined in claim 15, wherein said storage medium comprises a solid state storage device.
